(19) United States
(12) Patent Application Publication
(10) Pub. No.: US 2026/0067998 A1
(43) Pub. Date: Mar. 5, 2026

(54) MULTI-LAYRED ELECTRIC HEATING TILE

(71) Applicant: Design & Technical Solutions LLC, Wantagh, NY (US)

(72) Inventor: Sunghoon Jang, Glen Rock, NJ (US)

(21) Appl. No.: 19/379,976

(22) Filed: Nov. 5, 2025

Related U.S. Application Data
(63) Continuation-in-part of application No. 18/390,092, filed on Dec. 20, 2023.

(30) Foreign Application Priority Data
Sep. 26, 2023 (KR) 10-2023-0129584

(51) Int. Cl. H05B 3/28; H05B 1/02; H05B 3/03

(52) U.S. Cl. CPC H05B 3/28; H05B 1/02; H05B 3/03; H05B 2203/01; H05B 2203/026

(57) ABSTRACT

The present disclosure relates to an electric heat tile including: a first layer including at least one temperature sensor and a power line electrically connected to the temperature sensor; a second layer placed on an upper surface of the first layer and including an electric heating wire electrically connected to the power line; an upper cover covering an upper surface of the second layer; a lower cover covering a lower surface of the first layer, and a first thermally conductive sheet or paste attached to a side of the upper cover.

### TECHNICAL FIELD

The present disclosure relates to an electric heat tile including an electric heating wire, and, more particularly, to an electric heat tile in the shape of a block in which a temperature sensor and an electric heating wire are placed for a user to monitor the temperature of the tile and control the heating by the electric heating wire.

### BACKGROUND

In general, plate-shaped interior materials made of tiles, wood, metal synthetic resin, etc. are attached to interior walls of buildings to decorate a specific space.

Most of such interior materials in buildings have the problem of being heavy and are used only as interior materials that are designed to have a nice appearance but are not given any functionality.

Meanwhile, indoor heating in buildings is divided into two types: forced air heating, which warms cold air using an electric heater or by burning fuel such as natural gas etc. and blows it into a room; and radiant heating, which heats a floor or a wall and warms a room by radiation from the floor or the wall.

In particular, radiant heating is mainly used because it has better heating efficiency. Heating by such radiant heating is divided into heating by directing hot water through pipes under a floor or behind a wall to heat the floor or the wall, heating by embedding an electric heating wire in a floor or a wall to heat the floor or the wall, etc.

Here, in the case of radiant heating using hot water, water may leak as pipes rot or break, so heating using hot water has been gradually replaced by heating using electric heating wires.

However, heating using electric heating wires also has a problem in that a lot of labor and construction costs are required because of a series of complicated procedures involved therein: laying an electric heating wire under a floor or behind a wall and then pouring cement thereon, laying additional tiles for decoration or for covering the surface and fixing them on the top of cement that has hardened and dried, etc. In addition, in the case of heating using electric heating wires, electromagnetic waves harmful to the human body are generated in large quantities.

To solve such problems, floor heating using planar heating elements or linear heating elements that generate less electromagnetic waves and can easily transfer heat, has been used.

In particular, for the construction of floor heating using planar heating elements, insulation material is laid on a floor to be heated, and planar heating elements are applied thereon.

However, the planar heating elements are weak in strength so as to be easily damaged by external impact, and are weak against moisture so as to cause a fire due to short circuit. In addition, when some of the planar heating elements are damaged, repair is difficult.

Meanwhile, US Patent Application Publication No. US 2004/0109681 discloses a modular electric heating tile including a tile body and an electric heating unit. The tile body is made of a material selected from a group consisting of clay and cement, and has two opposite first and second surfaces. The electric heating unit is mounted on the tile body adjacent to the first surface in an enveloped manner.

However, in the case of the conventional technology, since a heating wire and a heat-conducting tile body are used as the heating medium, it is difficult to secure a sufficient connection area between the two, which may cause poor heat transfer, possibility of short circuit in the heating wire, etc. and reduces not only functionality but also safety.

In addition, in order to insert a heating wire into a square block base, a heating wire fitting groove and cavity has to be machined on the surface of the square block base before the heating wire is installed, which is disadvantageous in terms of manufacturing ability.

Therefore, in order to solve the above-mentioned problems, there is a need for research on heating tiles that are easy to construct and repair and can be used safely from accidents such as fire.

### SUMMARY

The present disclosure is aimed at providing an electric heat tile that is in the form of a ceramic module with a built-in electric heating wire and includes a fastening member on one side so as to be installed in a simple manner by being easily coupled to each other.

In addition, the present disclosure is aimed at providing an electric heat tile that includes a control module connected thereto to collect temperature data from a temperature sensor placed therein and control the heating by an electric heating wire based on the temperature data in a safe and easy manner.

The problems to be resolved by the present disclosure are not limited to the problems mentioned above, and the following description will allow a person having ordinary skill in the technical field to which the present disclosure pertains to clearly understand other problems to be solved by the present disclosure that are not mentioned herein.

An electric heat tile according to an embodiment of the present disclosure may include a first layer including at least one temperature sensor and a power line electrically connected to the temperature sensor; a second layer placed on an upper surface of the first layer and including an electric heating wire electrically connected to the power line; an upper cover covering an upper surface of the second layer; a lower cover covering a lower surface of the first layer, and a first thermally conductive sheet or paste attached to a side of the upper cover.

An electric heat tile according to an embodiment of the present disclosure may include a first layer including at least one temperature sensor and a power line electrically connected to the temperature sensor and a positive terminal and a negative terminal connected to the power line; a second layer placed on an upper surface of the first layer and including an electric heating wire electrically connected to the power line, a first terminal connected to the electric heating wire and provided on a position corresponding to a position where the positive terminal is provided for the first layer, and a second terminal connected the electric heating wire and provided on a position corresponding to a position where the negative terminal is provided for the first layer; an upper cover covering an upper surface of the second layer; and a lower cover covering a lower surface of the first layer, and the lower cover may have, on one side, at least one fastening member electrically connected to the power line formed on the first layer.

The electric heat tile may further include a control module that controls the heating by the electric heating wire, and the control module may include a power supply unit that supplies power to the temperature sensor and the power line, a communication unit that receives a user's control signal from a predetermined user terminal, and a heating wire control unit that controls the heating by the electric heating wire based on the user's control signal received from the communication unit.

The lower cover may further include a cable having one end coupled with the fastening member and the other end connected to the control module.

The first layer may further include a communication tag, the control module may further include a tag recognition unit that recognizes the communication tag, and the tag recognition unit may include a code assigning unit that assigns a unique order to the communication tags when at least two communication tags are recognized and a temperature collection unit that collects the temperature data from the temperature sensor based on the unique order.

The second layer may include a first terminal provided at one end of the electric heating wire at a position corresponding to the position of a positive terminal provided on the first layer; and a second terminal provided at the other end of the electric heating wire at a position corresponding to the position of a negative terminal provided on the first layer, the first terminal and the second terminal may be respectively connected to the positive terminal and the negative terminal by soldering, and conductive paste may be applied to the soldered area.

An electric heat tile according to an embodiment of the present disclosure may include a temperature sensor; and a sensor error monitoring unit to determine whether a foreign matter has adhered to the temperature sensor or not based on temperature data collected by the temperature sensor, wherein the sensor error monitoring unit, after calculating an average value of sensor values and standard deviation, specifies sensor values outside the standard deviation as noise data, calculates time intervals between the specified noise data, and determines that a foreign matter has adhered to the temperature sensor if the time intervals between the noise data are not constant.

The present disclosure may provide an electric heat tile that is in the form of a ceramic module with a built-in electric heating wire and includes a fastening member on one side so as to be installed in a simple manner by being easily coupled to each other.

In addition, the present disclosure may provide an electric heat tile that includes a control module connected thereto to collect temperature data from a temperature sensor placed therein and control the heating by an electric heating wire based on the temperature data in a safe and easy manner.

### BRIEF DESCRIPTION OF THE DRAWINGS

FIG. 1 is a view of an electric heat tile according to an embodiment of the present disclosure.

FIG. 2 is a view for illustrating a first layer of the electric heat tile according to an embodiment of the present disclosure.

FIG. 3 is a view for illustrating a second layer of the electric heat tile according to an embodiment of the present disclosure.

FIGS. 4 to 6 are views for illustrating a lower cover of the electric heat tile according to an embodiment of the present disclosure.

FIG. 7 is a view for illustrating a control module of the electric heat tile according to an embodiment of the present disclosure.

FIG. 8 is a view for illustrating how the first and second layers of the electric heat tile according to an embodiment of the present disclosure are combined.

### DETAILED DESCRIPTION

Specific details, including the problems to be solved by the present disclosure, the means for solving the problems, and the effects of the present disclosure, as described above, are included in the embodiments and the drawings described below. The advantages and the features of the present disclosure and the methods of achieving them will become clear by referring to the embodiments described in detail below along with the accompanying drawings.

The scope of the present disclosure is not limited to the embodiments described below, and various modifications may be made by a person having ordinary skill in the art within the technical gist of the present disclosure.

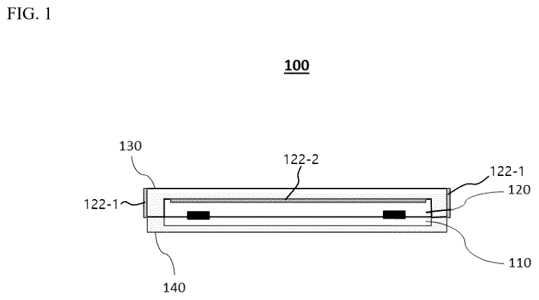

Hereinafter, the present disclosure having the title of the invention will be described in detail with reference to the attached FIG. 1.

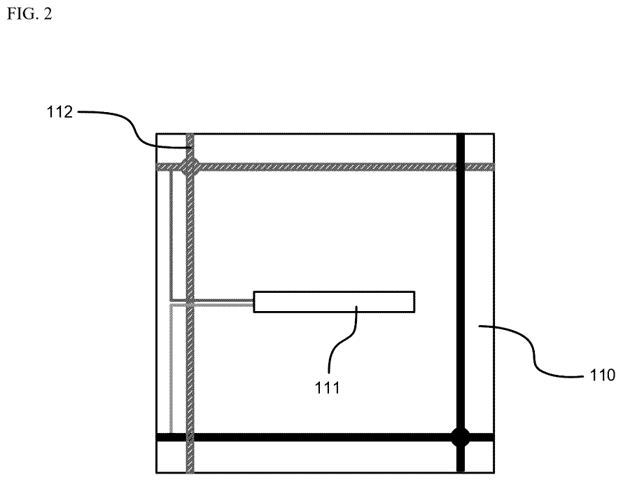

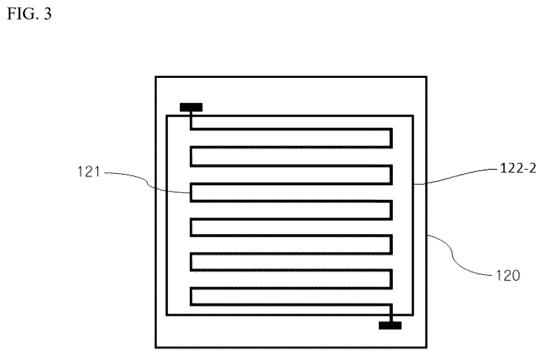

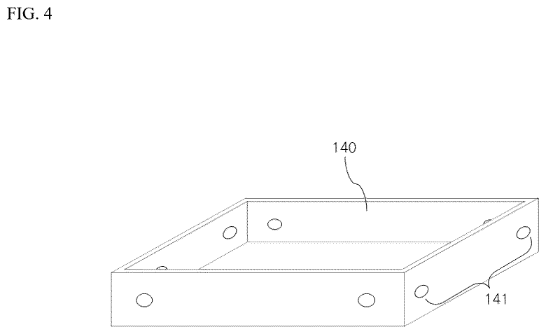

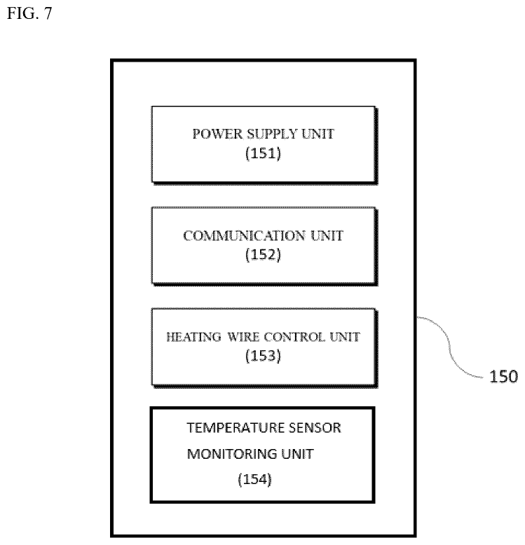

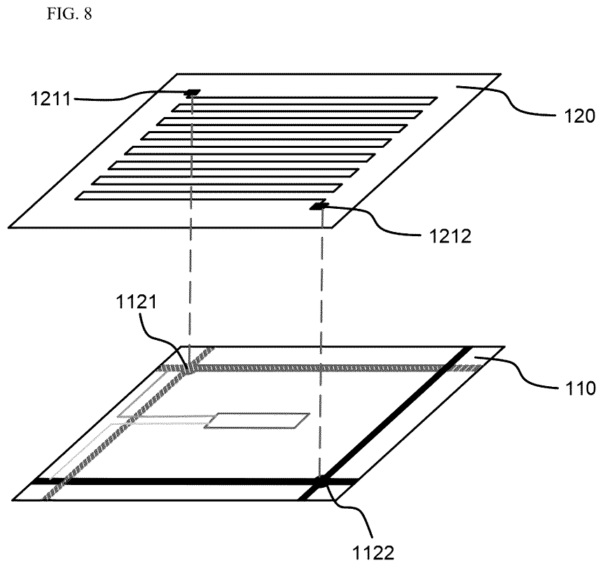

FIG. 1 is a view of an electric heat tile according to an embodiment of the present disclosure, FIG. 2 is a view for illustrating a first layer of the electric heat tile according to an embodiment of the present disclosure, FIG. 3 is a view for illustrating a second layer of the electric heat tile according to an embodiment of the present disclosure, FIGS. 4 to 6 are views for illustrating a lower cover of the electric heat tile according to an embodiment of the present disclosure, FIG. 7 is a view for illustrating a control module of the electric heat tile according to an embodiment of the present disclosure, and FIG. 8 is a view for illustrating how the first and second layers of the electric heat tile according to an embodiment of the present disclosure are combined.

### Embodiment 1

Referring to FIGS. 1 to 3, an electric heat tile 100 according to an embodiment of the present disclosure may include at least one temperature sensor 111, a first layer 110 on which a power line 112 electrically connected to the temperature sensor 111 is formed, a second layer 120 placed on an upper surface of the first layer 110 and including an electric heating wire 121 electrically connected to the power line 112, an upper cover 130 covering an upper surface of the second layer 120, and a lower cover 140 covering a lower surface of the first layer 110.

For example, the upper cover 130 may be made of various materials such as ceramic, wood, and synthetic resin, and the lower cover may be made of synthetic resin such as PVC.

For example, the thickness of the air gap formed between the first layer 110 and the upper cover 130 may be less than a preset maximum thickness (e.g., 10 mm).

Meanwhile, referring to FIG. 4, the lower cover 140 may have, on one side, at least one fastening member 141 electrically connected to the power line 112 formed on the first layer 110.

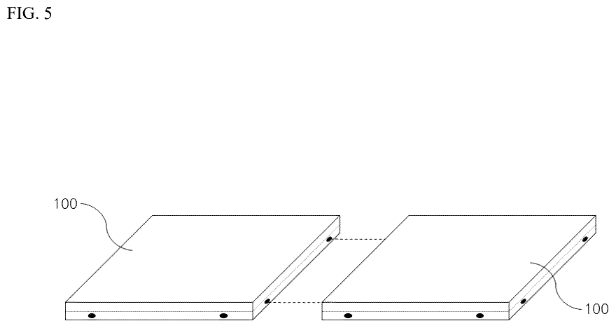

As shown in FIG. 5, the electric heat tile 100 may be coupled to each other by the fastening member 141. That is, because the electric heat tile 100 may be formed in the form of a module to be assembled, it may be possible to place the electric heat tile 100 not only in the entire area but also in partial areas requiring construction.

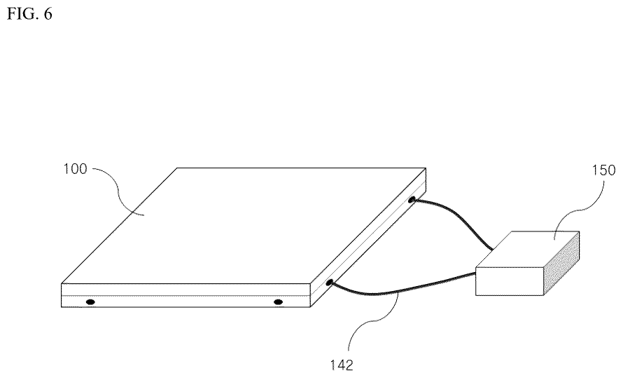

Meanwhile, referring to FIGS. 6 and 7, the electric heat tile 100 may further include a control module 150 that controls the heating by the electric heating wire.

The lower cover 140 may include a cable 142 having one end coupled with the fastening member 141 and the other end connected to the control module 150.

For example, a groove into which the cable 142 is inserted may be formed in the area of the lower cover 140 where the fastening member 141 is placed.

Accordingly, after the electric heat tiles 100 are coupled to each other, it may be possible to pull the cable 142 out of any one of the electric heat tiles 100 and connect it to the control module 150.

Meanwhile, the control module 150 may include a power supply unit 151 that supplies power to the temperature sensor 111 and the power line 112, a communication unit 152 that receives a user's control signal from a predetermined user terminal, and a heating wire control unit 153 that controls the heating by the electric heating wire 121 based on the user's control signal received from the communication unit 152.

For example, the user's control signal may include information about a heating reservation time, the highest heating temperature, the lowest heating temperature, etc.

Therefore, the heating wire control unit 153 may control the heating by the electric heating wire 121 by adjusting the level of the voltage applied to the electric heating wire 121, a duty rate, etc. based on the user's control signal.

The power supply unit 151 may be implemented by a hardware circuit or a processor controlling a power conversion device to supply power to the temperature sensor 111 and the power line 112.

The communication unit 152 may be implemented by a communication interface or a processor executing a communication protocol program to receive a user's control signal from a user terminal.

The heating wire control unit 153 may be implemented by a processor executing a control algorithm or by a dedicated control circuit to adjust the voltage level or duty ratio applied to the electric heating wire 121 based on the received control signal.

Each of the above units may be implemented by hardware, software, or a combination thereof.

Meanwhile, the first layer 110 may further include a communication tag (not shown), and the control module 150 may further include a tag recognition unit (not shown) that recognizes the communication tag.

More specifically, the tag recognition unit may include a code assigning unit that assigns a unique order to the communication tags when at least two communication tags are recognized and a temperature collection unit that collects temperature data from the temperature sensor based on the unique order.

Therefore, when the plurality of electric heat tiles 100 are combined, each of the plurality of electric heat tiles 100 may be recognized by the tag recognition unit, and a unique order may be assigned to a communication tag included in the electric heat tile 100, so that it may be possible to monitor the temperature of each of the plurality of electric heat tiles 100.

For example, when four electric heat tiles 100 are arranged, the control module 150 may recognize each of the electric heat tiles 100 through communication tags included in the electric heat tiles 100. In this case, it may be possible to monitor the heating by each of the electric heat tiles 100.

Therefore, it may be possible to monitor whether an error has occurred in the temperature sensor 111 and the electric heating wire 121 included in each of the electric heat tiles 100, and it may be possible for the electric heat tile 100 in which an error has occurred to be quickly replaced.

Meanwhile, as shown in FIG. 8, the second layer 120 may include a first terminal 1211 provided at one end of the electric heating wire 121 at a position corresponding to the position of a positive terminal 1121 provided on the first layer 110 and a second terminal 1212 provided at the other end of the electric heating wire 121 at a position corresponding to the position of a negative terminal 1122 provided on the first layer 110.

In that case, in order to electrically connect the first layer 110 and the second layer 120, the first terminal 1211 and the second terminal 1212 may be respectively connected to the positive terminal 1121 and the negative terminal 1122 by soldering, and conductive paste may be applied to the soldered area.

For another example, a first thermally conductive sheet or paste 122-1 may be attached to the side of the upper cover 130, so that, when the plurality of electric heat tiles 100 are combined with each other, heat may be quickly conducted between the electric heat tiles 100. The electric heating tile 100 may include a second thermally conductive sheet or paste 122-2 that may be disposed between the upper cover 130 and the electric heating wire 121. The thermally conductive sheet or paste 122-1 and 122-2 may be made of a metal such as copper, iron, steel, stainless, aluminum or the like. The electric heating tile 100 has the first layer 110 and the second layer 120 that may mutually face and be flat.

### Embodiment 2

Meanwhile, referring to FIG. 7, in order to determine whether noise is generated due to foreign substances, etc. attached to the temperature sensor 111, the control module 150 may further include a sensor error monitoring unit 154 that receives collected data from the temperature sensor and analyzes them. The sensor error monitoring unit 154 may be realized or implemented by hardware, software, or a combination thereof. For example, the sensor error monitoring unit 154 may be implemented by a processor executing instructions stored in a non-transitory computer-readable medium to perform the operations described herein.

In other words, when foreign substances are attached to the surface of the temperature sensor, the values measured by the sensor will show irregular patterns. In this regard, it may be possible to not only determine whether foreign substances are attached to the surface of the sensor but also determine whether an error has occurred in the operation of the sensor, taking such characteristics into account.

To this end, the sensor error monitoring unit 154 may calculate the average and the standard deviation of multiple values measured by the sensor 111 for a preset period of time. When the number of values outside the standard deviation from the average of the multiple values (hereinafter, referred to as “noise data”) is equal to or more than a preset number (e.g., five), the sensor error monitoring unit 154 may assume that there are foreign substances attached to the surface of the sensor 111.

The sensor error monitoring unit 154 may determine whether a foreign matter has adhered to the temperature sensor or not based on temperature data collected by the temperature sensor 111. The sensor error monitoring unit 154, after calculating an average value of sensor values and standard deviation, may specify sensor values outside the standard deviation as noise data, calculate time intervals between the specified noise data, and determine that a foreign matter has adhered to the temperature sensor if the time intervals between the specified noise data are not constant.

Here, when the maximum difference value (M_{d}) of the time intervals between the noise data calculated according to Equation 1 below is equal to or greater than a value calculated by multiplying the average of the time intervals between the noise data (Tₐvg) calculated according to Equation 2 below by a constant (e.g., two), it cannot be determined that the time interval is constant.

$${M}_{d} = {N}_{max} - {N}_{min} \qquad [ Equation 1 ]$$

wherein M_{d} is the maximum difference value of time intervals between noise data, Nₘₐₓ is the maximum value of the time intervals between the noise data, and Nₘᵢₙ is the minimum value of the time intervals between the noise data.

$${T}_{avg} = \frac{{\sum }_{i = 1}^{n} {T}_{( i - 1 ) to i}}{n} \qquad [ Equation 2 ]$$

Wherein T_{avg} is the average value of time intervals between noise data, T_{(i-1) to i} is the time interval between the i−1th noise data and the ith noise data, T_{0 to 1} is the time interval between the time point when the sensor started operating and the time point when the first noise data appeared, and n is the number of noise data.

For example, as shown in Table 1 below, when the data of T₀ to T₂₀ is 9, 10, 11, 12, 14, 18, 9, 9, 6, 13, 2, 8, 9, 9, 10, 17, 9, 10, 3, and 12, the average is 10, and the standard deviation is 3.88. Therefore, there are six note data: 14, 18, 6, 2, 17, and 3. Since the number of noises is greater than the preset value of 5, it can be assumed that there are foreign substances attached to the surface of the sensor.

TABLE 1

| | | | | | | | | | | | | | | | | | | | | | | standard |
|---|---|---|---|---|---|---|---|---|---|---|---|---|---|---|---|---|---|---|---|---|---|---|
| t | 1 | 2 | 3 | 4 | 5 | 6 | 7 | 8 | 9 | 10 | 11 | 12 | 13 | 14 | 15 | 16 | 17 | 18 | 19 | 20 | average | deviation |
| Value obtained | 9 | 10 | 11 | 12 | 14 | 18 | 9 | 9 | 6 | 13 | 2 | 8 | 9 | 9 | 10 | 17 | 9 | 10 | 3 | 12 | 10 | 3.88 |
| by sensor | | | | | | | | | | | | | | | | | | | | | | |
| Whether there | | | | | N | N | | | N | | N | | | | | N | | | N | | | |
| is a noise (N) | | | | | | | | | | | | | | | | | | | | | | |

The result of the calculation according to Equation 1 and Equation 2 to determine whether a noise appears irregularly is as follows: As shown in Table 2 below, the maximum difference (M_{d}) of the time intervals between the noise data is seven, which is eight minus one, and the average (T_{avg}) of the time intervals between the noise data is 3.5.

TABLE 2

| Noise data (T_{(i-1) to i}) | T₀₁ | T₁₂ | T₂₁ | T₃₄ | T₄₅ | T₅₆ | T_{avg} |
|---|---|---|---|---|---|---|---|
| Time interval | 5 | 1 | 3 | 2 | 8 | 2 | 3.5 |
| between noise data | | | | | | | |

Therefore, since 7, which is the maximum difference value (M_{d}) of the time intervals between the noise data, falls within the values that are equal to or greater than twice 3.5, which is the average (T_{avg}) of the time intervals between the noise data, it can be confirmed that there are foreign substances attached to the surface of the sensor.

As described above, according to an embodiment of the present disclosure, it may be possible to monitor and sense errors caused by foreign substances attached to the surface of the sensor through the sensor error monitoring unit, so that it may be possible to more accurately determine whether the temperature sensor is operating normally.

The electric heat tile according to the present disclosure may be in the form of a ceramic module with a built-in electric heating wire and include a fastening member on one side, so as to be installed in a simple manner by being easily coupled to each other.

In addition, the electric heat tile according to the present disclosure may include the control module connected thereto so as to collect temperature data from the temperature sensor provided therein and control the heating by the electric heating wire based on the temperature data in a safe and simple manner.

In addition, a method of controlling the electric heat tile according to an embodiment of the present disclosure may be recorded on a computer-readable medium including program commands for performing various operations that can be carried out by a computer. The computer-readable medium may individually include program commands, data files, data structures, etc., or may include combinations thereof. The program commands of the medium may be specifically designed and constructed for the present disclosure, or may be available by being widely known to those having ordinary skill in the art of computer software. Examples of the computer-readable recording medium may include magnetic media such as hard disks, floppy disks, and magnetic tapes, optical media such as CD-ROMs and DVDs, magneto-optical media such as floptical disks, and hardware devices specifically designed to store and execute program commands, such as ROMs, RAMs, and flash memories. Examples of program commands may include not only machine language codes such as those created by a compiler, but also high-level language codes that can be executed by a computer using an interpreter, etc.

Although an embodiment of the present disclosure has been described with reference to the limited examples and drawings, it is not limited to the above-described examples. A person having ordinary skill in the field to which the present disclosure pertains would be able to make various modifications and variations to the examples described herein. Therefore, the embodiment of the present disclosure should be understood only by the claims set forth below, and all of equivalents or equivalent modifications thereof should be deemed to fall within the scope of the technology of the present disclosure.

What is claimed:

1. An electric heat tile comprising:
a first layer including at least one temperature sensor and a power line electrically connected to the temperature sensor;
a second layer placed on an upper surface of the first layer and including an electric heating wire electrically connected to the power line;
an upper cover covering an upper surface of the second layer;
a lower cover covering a lower surface of the first layer, and
a first thermally conductive sheet or paste attached to a side of the upper cover.

2. The electric heat tile of claim 1, further comprising a second thermally conductive sheet or paste inserted between the upper cover and the second layer.

3. The electric heat tile of claim 1, wherein mutually facing surfaces of the first layer and the second layer are flat.

4. The electric heat tile of claim 1, wherein the first layer further includes a positive terminal and a negative terminal connected to the power line, and
wherein the second layer further includes a first terminal connected to the electric heating wire and provided on a position corresponding to a position where the positive terminal is provided for the first layer, and a second terminal connected to the electric heating wire and provided on a position corresponding to a position where the negative terminal is provided for the first layer.

5. The electric heat tile of claim 4, wherein the power line includes:
a first power line extending in a first direction;
a second power line extending in a second direction intersecting the first direction and intersecting the first power line;
a third power line opposing the first power line in the second direction and extending in the first direction; and
a fourth power line opposing the second power line in the first direction and extending in the second direction and intersecting the third power line,
wherein the positive terminal is located at an intersection point between the first power line and the second power line, and the negative electrode terminal is located at an intersection point between the third power line and the fourth power line.

6. The electric heat tile of claim 5, wherein the first layer includes a first side and second side opposing each other in the first direction and a third side and a fourth side opposing each other in the second direction,
wherein the first power line and the third power line extend from the first side to the second side, and wherein the second power line and the fourth power line extend from the third side to the fourth side.

7. The electric heat tile of claim 5, wherein the temperature sensor is encompassed by the first power line, the second power line, the third power line, and the fourth power line.

8. An electric heat tile comprising:
The first layer includes at least one temperature sensor, a power line electrically connected to the temperature sensor, and a positive terminal and a negative terminal connected to the power line; and a second layer placed on an upper surface of the first layer and including an electric heating wire electrically connected to the power line, a first terminal connected to the electric heating wire and provided on a position corresponding to a position where the positive terminal is provided for the first layer, and a second terminal connected the electric heating wire and provided on a position corresponding to a position where the negative terminal is provided for the first layer.

9. An electric heat tile comprising:
a temperature sensor; and
a sensor error monitoring unit to determine whether a foreign matter has adhered to the temperature sensor or not based on temperature data collected by the temperature sensor,
wherein the sensor error monitoring unit, after calculating an average value of sensor values and standard deviation, specifies sensor values outside the standard deviation as noise data, calculates time intervals between the specified noise data, and determines that a foreign matter has adhered to the temperature sensor if the time intervals between the noise data are not constant.

10. The electric heat tile according to claim 9, wherein
the sensor error monitoring unit determines whether the time intervals are constant or not based on a maximum difference value M_{d} and the average time intervals Tₐᵥ between the noise data,
where the maximum difference value M_{d} between the time intervals of the noise data satisfies the following equation:
$${M}_{d} = {N}_{max} - {N}_{min} \qquad [ Eq . 1 ]$$
where Nₘₐₓ is a maximum time interval between noise data, Nₘᵢₙ is a minimum time interval between noise data points, and the average value T_{avg} satisfies the following equation:
$${T}_{avg} = \frac{{\sum }_{i = 1}^{n} {T}_{( i - 1 ) to i}}{n} \qquad [ Eq . 2 ]$$
where T_{(i-1) to i} is a time interval between an (i−1)-th noise data and an i-th noise data, T_{0 to 1} is a time interval between a sensor start time point and a time point where a first noise data appeared, and n is a number of noise data points.

11. The electric heat tile according to claim 10, wherein
the sensor error monitoring unit determines that the time intervals are not constant if the maximum difference value M_{d} is greater than or equal to a predetermined constant multiple of the average time Tₐvg between the noise data, and determines that the time intervals are constant if the maximum difference value M_{d} is less than the predetermined constant multiple of the average time Tₐvg between the noise data.

12. The electric heat tile according to claim 11, wherein
the predetermined constant is 2.

13. The electric heat tile according to claim 9, further comprising:
a first layer provided with the temperature sensor and a power line electrically connected to the temperature sensor;
a second layer placed on an upper surface of the first layer and including an electric heating wire electrically connected to the power line;
an upper cover covering an upper surface of the second layer; and
a lower cover covering a lower surface of the first layer,
wherein the lower cover has, on one side, at least one fastening member electrically connected to the power line formed on the first layer.

14. The electric heat tile according to claim 10, further comprising:
a first layer provided with the temperature sensor and a power line electrically connected to the temperature sensor;
a second layer placed on an upper surface of the first layer and including an electric heating wire electrically connected to the power line;
an upper cover covering an upper surface of the second layer; and
a lower cover covering a lower surface of the first layer,
wherein the lower cover has, on one side, at least one fastening member electrically connected to the power line formed on the first layer.

15. The electric heat tile according to claim 11, further comprising:
a first layer provided with the temperature sensor and a power line electrically connected to the temperature sensor;
a second layer placed on an upper surface of the first layer and including an electric heating wire electrically connected to the power line;
an upper cover covering an upper surface of the second layer; and
a lower cover covering a lower surface of the first layer,
wherein the lower cover has, on one side, at least one fastening member electrically connected to the power line formed on the first layer.

16. The electric heat tile according to claim 12, further comprising:
a first layer provided with the temperature sensor and a power line electrically connected to the temperature sensor;
a second layer placed on an upper surface of the first layer and including an electric heating wire electrically connected to the power line;
an upper cover covering an upper surface of the second layer; and
a lower cover covering a lower surface of the first layer,
wherein the lower cover has, on one side, at least one fastening member electrically connected to the power line formed on the first layer.
